(19) United States
(12) Patent Application Publication
(10) Pub. No.: US 2007/0203431 A1
(43) Pub. Date: Aug. 30, 2007

(54) Therapeutic device

(76) Inventor: Guy Leta, Ronse (BE)

Correspondence Address: JAMES C. WRAY, 1493 CHAIN BRIDGE ROAD, SUITE 300, MCLEAN, VA, 22101, US

(21) Appl. No.: 11/710,048

(22) Filed: Feb. 23, 2007

(30) Foreign Application Priority Data
Feb. 28, 2006 (BE) 2006/0127

(51) Int. Cl. A61H 1/00; A61H 1/02; A61H 5/00

(52) U.S. Cl. 601/2; 601/15

(57) ABSTRACT

This invention relates, on the one hand, to a therapeutic device, comprising a bearing element (1) consisting substantially of a natural stone, a surface of which is provided as a treatment surface (2) and means (4) to heat said bearing element (1). The bearing element, which is preferably of lava rock, steatite and/or some other natural stone, is provided on the treatment surface (2), with a number of therapeutic units (12) which comprise at least one product from the following group: a semi-precious stone, a precious stone, a precious metal, copper. The heat coming out of the natural stone penetrates deeply into the body. The therapeutic units (12) provide additional effects in the human body, so that a very extensive and efficient treatment with lasting effect becomes possible. The device preferably comprises at least one infrared radiation element and a superstructure (6) with a mirror-like or reflective wall which in a use position provides a roof over the treatment surface (2).

This invention relates to a therapeutic device, comprising a bearing element, one surface of which is provided as a treatment surface, and means for heating said bearing element.

This invention relates in particular to such a device in which the treatment surface acts as a sitting or lying surface for a person or animal to be treated.

Devices which are provided for carrying out therapeutic treatments and in which a heating element is accommodated are generally known. For instance, Japanese patent publication JP 11047181 discloses a sitting and lying surface which can be heated by means of a heat-resistant and heat-retaining stone in order to obtain a therapeutic effect for a person.

However, such therapeutic devices have the great disadvantage that their therapeutic effect tends to be slight. The heating is only superficial and only has a relaxing and pain-alleviating effect of short duration. The object of this invention is to provide such a therapeutic device by means of which a more extensive therapeutic treatment with a greater and more lasting effect can be given.

This object is achieved by providing such a therapeutic device in which the abovementioned bearing element consists substantially of a natural stone and on the treatment surface is provided with a number of therapeutic units which can comprise at least one product from the following group: semi-precious stone, precious stone, precious metal, copper, so that during use of the device the body of a person or animal present on the treatment surface (2) comes into direct contact with the abovementioned therapeutic units.

Certain natural stones, such as, inter alia, lava rock and steatite (also called soapstone) have the property that they accumulate heat very quickly and also release the heat again very gradually and uniformly, which makes them extremely suitable for use in heating elements.

A further advantage of the use of natural stones is that they are not porous and are therefore not susceptible to the absorption of fluids, so that, inter alia, little or no perspiration will be absorbed in the bearing element.

Yet an additional advantage of certain natural stones, such as steatite, is that they release heat with wavelengths lying at the same level as the heat wavelengths of the human or animal body, so that said wavelengths pass more easily through the epidermis and penetrate more deeply and they are thus absorbed into the bloodstream.

Owing to the fact that a surface of the abovementioned bearing element of natural stone or lava rock is provided as a treatment surface, there is also direct contact between the body and the heated natural stone or lava rock, with the result that the heat penetrates more deeply into the body.

The heat provides, inter alia, alleviation of the pain of osteoarthritis, rheumatoid forms of arthritis etc. . . . , particularly by the fact that the heat causes drainage and elimination of toxins from the deep organs (joints, joint sockets, internal organs) by way of the lymphatic system, by means of perspiration (i.e. elimination of toxic substances).

The therapeutic effect of the heat coming from natural stones, such as steatite (soapstone) or lava rock is also used for the treatment of cellulite. The effect of the heat is then as follows. The combination of heat and dryness radiates and penetrates into the deepest level. The result is that the moisture in the body is heated and dries up. The cellulite is therefore metabolized and drained by way of the lymphatic system and the urinary tract. The skin recovers its firmness and elasticity and the body girth is reduced. The deep penetration of heat therefore has the effect of reducing swelling.

Through the presence of the abovementioned therapeutic units on the treatment surface, so that they come into direct contact with the body, a treatment with the therapeutic device according to this invention furthermore produces yet additional effects, or the effects already mentioned are reinforced.

For example, precious stones and semi-precious stones produce mineralization of the body, since these products release minerals which are absorbed by the body. When precious metals or copper are used in the therapeutic units, the body which comes into contact with these metals absorbs small quantities of these metals. This also has a beneficial therapeutic effect.

Semi-precious stones, precious stones, precious metals such as gold and silver, and copper also have the property that in addition they send out vibrations with a typical characteristic frequency, and that said frequency corresponds to or is in the region of the frequency of certain organs of a human body. Each of these products can consequently influence the functioning of one or more organs of the body. The table included further on in this patent application indicates the therapeutic effect produced by a series of different products.

Tourmaline, for example, is a semi-precious stone which can produce a slight electric current and acts upon the nerves, so it is best provided along the spinal column on the treatment surface. Bloodstone is another known semi-precious stone material which can be provided on the treatment surface of the therapeutic device according to this invention. Bloodstone eliminates iron deficiencies and gives energy and warmth.

These semi-precious stones promote and boost, for example, the deep penetration of heat through to the spinal column. As a result, the heat penetrates deeply through the nervous system and is felt through to the level of the bone. This is very important, since all nerves originate at the level of the spinal column.

Once the heat has penetrated to the bone and the spinal column, the neurovegetative nervous system relaxes, so that only then are waste substances (in the form of perspiration) released on a massive scale from deep down to the surface of the body.

Coral and red jaspis, other kinds of semi-precious stones, act primarily upon the blood circulation and ensure free circulation of blood through the large joints. This is important because each joint acts as a pump and thus provides for maximum drainage and elimination of toxins.

In a preferred embodiment of the therapeutic device according to this invention the abovementioned heating means are provided in order to bring the treatment surface to a temperature lying between 40° C. and 50° C., preferably approximately 49° C. to 50° C. Of course, this temperature range can be extended, and the treatment surface can be brought to temperatures from, for example, 37° C. to a maximum of approximately 60° C.

The heating means preferably also comprise a hot water circuit, which is provided in order to heat the bearing element. It goes without saying that the heating of the treatment surface can also be achieved in some other way, such as, inter alia, by means of electric heating elements. A combination of two or more different heating means is also among the possibilities.

In order to keep the temperature as constant as possible, the heating system also preferably comprises a thermostat.

In a particularly preferred embodiment the bearing element can be composed substantially of lava rock or steatite (also called soapstone). The advantageous properties of these materials have already been indicated above.

The abovementioned therapeutic units comprise, for example, one or more semi-precious stone materials from the following group: crystal, moonstone, pearl, coral, garnet, red jasper, bloodstone, carnelian, fire opal, yellow topaz, amber, lemon quartz, common tourmaline, pink tourmaline, tourmaline, water melon kunzite, rhodochrosite, emerald, malachite, jade, green tourmaline, nickel oxide green coloured agate, peridot, aquamarine, turquoise, chrysocolla, lapis lazuli, blue topaz, indigo sapphire, copper lazulite, amethyst and fluorite, red jaspis.

These therapeutic units can, for example, also comprise one or more gemstone materials from the diamond, ruby and sapphire group.

In a particularly preferred embodiment a lying zone for a human or animal body is indicated on the treatment surface, and the therapeutic units are provided within this lying zone on the treatment surface.

This therapeutic device preferably also comprises a treatment surface in which the shape of the human or animal body is modelled.

A most preferred therapeutic device is obtained if on the treatment surface:
in a zone which is provided for the spinal column of a person to be treated, one or more therapeutic units comprising tourmaline are provided,
in a zone which is provided for the lumbar region and/or the bottom of a person to be treated, one or more therapeutic units comprising garnet are provided,
in a zone which is provided for the dorsal part of a person to be treated, one or more therapeutic units comprising bloodstone are provided,
in (a) zone(s) which is (are) provided for a shoulder or a hip part or the bottom or a leg of a person to be treated, one or more therapeutic units comprising coral and/or jaspis is provided.

In this embodiment the various therapeutic units are provided on the treatment surface in the zones provided for the parts of the body and/or the organs on which their respective therapeutic effect is greatest.

Another particular embodiment of this therapeutic device comprises a superstructure which is provided so as to extend above the treatment surface during use of the device. Said superstructure can be in the form of a curved wall which forms a full or partial roof over the treatment surface.

The device is extremely user-friendly if the superstructure is in the form of a removable part, or if said superstructure can be moved to an open position in which the treatment surface is largely not covered by the superstructure.

The superstructure can then, for example, be pushed away out of the use position or folded out into the open position.

A person to be treated can be seated without hindrance on the treatment surface when the superstructure is placed in the open position. When this person is sitting or lying on the treatment surface, the superstructure is moved back into the use position before the treatment is started.

In order to obtain efficient heat reflection, at least one wall of the abovementioned superstructure facing the treatment surface can be designed with a reflective or a mirror-like surface.

Furthermore, the device can be made even more efficient by providing means for generating infrared radiation, such as, for example, at least one infrared radiation element, which is preferably directed towards the treatment surface. The infrared radiation heats not only the body, but also the therapeutic units, so that the latter retain their properties longer.

A possible preferred embodiment of a therapeutic device according to this invention will be described in more detail below, for the purpose of clarifying and adding to the features of the invention. It will probably be clear that the description which follows cannot be interpreted as a limitation of the scope of protection for this invention defined in the claims, or of its field of application.

In this description reference numerals will be used to refer to the appended drawings, in which:

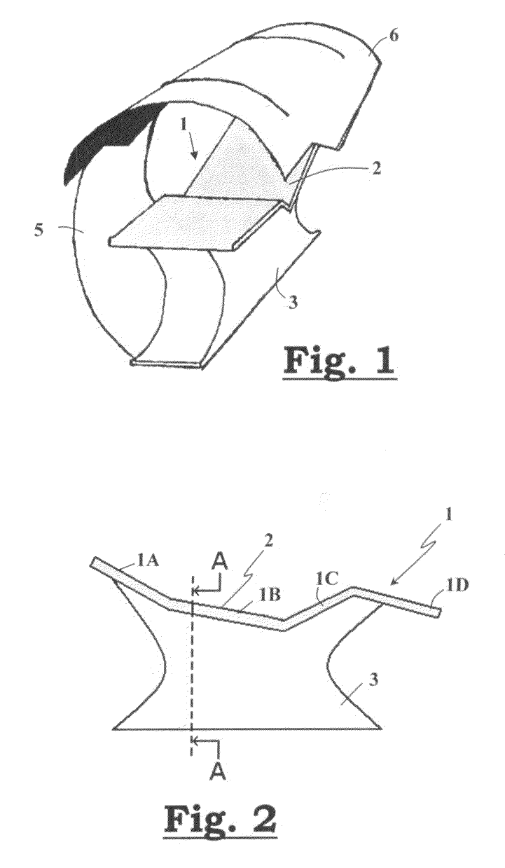

FIG. 1 is a perspective drawing of a particular embodiment of the device according to this invention,

FIG. 2 illustrates a diagrammatic side view of the therapeutic device according to this invention illustrated in FIG. 1,

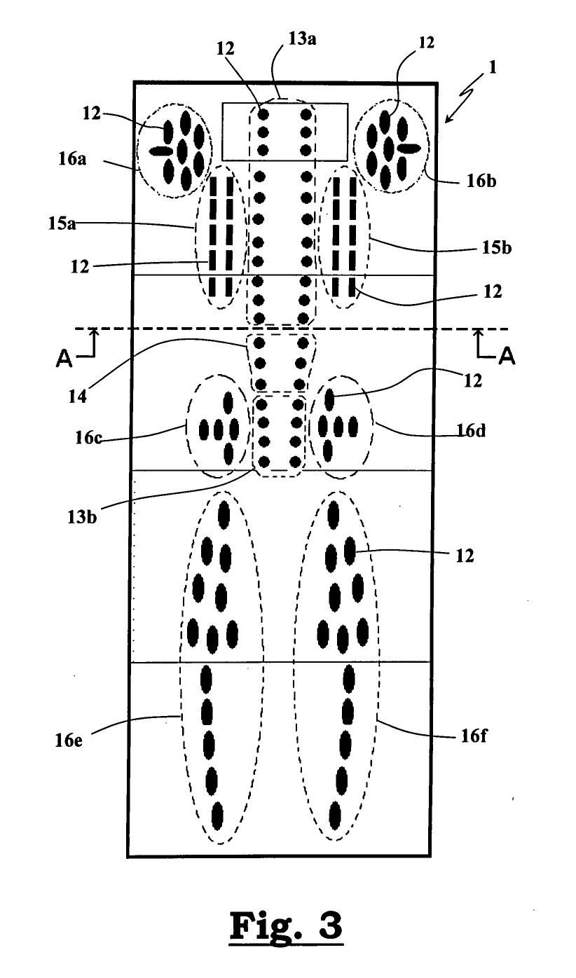

FIG. 3 illustrates a diagrammatic top view of the treatment surface with therapeutic units of a device according to this invention,

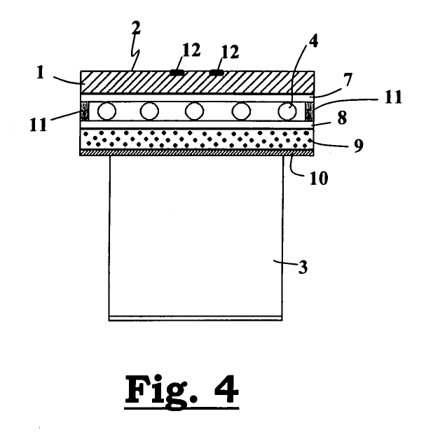

FIG. 4 is a cross section along the axis A-A in FIGS. 2 and 3.

The device illustrated in the figures is a therapeutic table with a tabletop (1) of soapstone. The upper surface (2) of said tabletop acts as a treatment surface (2) and is formed in such a way that it forms a comfortable lying surface for a person to be treated.

The tabletop (1) comprises four parts (1a), (1b), (1c) and (1d) with respective flat upper sides which connect to each other forming an angle. The upper sides of the first part (1a) and the second part (1b) describe an angle of inclination of approximately 31° and approximately 8° respectively relative to an imaginary horizontal line. For the third part (1c) and the fourth part (1d) said angle of inclination is approximately 23° and approximately 14° respectively.

The tabletop (1) is supported by a base element (3), which is a structure made, for example, substantially of wood and/or plastic. Between the upper side of this structure and the tabletop (I) is a copper pipe (4) which describes a number of successive U-shaped paths, running back and forth in the longitudinal direction of the tabletop (1). Said pipe (4) is connected to a heating system which is provided in order to send hot water through said pipe (4) for the purpose of heating the tabletop (1). The temperature of the water can be kept constant by means of a thermostat. The temperature of the tabletop (1) can be set at a value between 37° C. and 60° C., preferably at 49 to 50° C.

As can be seen clearly in the cross section shown in FIG. 4, the copper pipe (4) is provided between two copper plates (7), (8). Said plates (7), (8) have virtually the same surface area as the tabletop (1). The top plate (7) is in contact with said tabletop (1), while the bottom plate rests upon a layer of insulating material (9), such as, for example, a layer of rock wool with a thickness of 6 cm, provided with a reflective layer. Finally, between said insulating material (9) and the upper side of the base element (3) there is also a protective mat (10) made of rubber.

A number of spacers (11) are provided between the top copper plate (7) and the bottom copper plate (8).

The shape of a human body (not illustrated in the figures) as a lying zone is preferably indicated on the upper side of the tabletop. A number of therapeutic units (12), consisting of different semi-precious stones, are provided in the tabletop (1) within said lying zone, in such a way that the body of a person lying on the tabletop comes into contact with said semi-precious stones (12).

The zones within which the same type of semi-precious stones are provided are indicated by a dashed line in FIG. 3.

When a person is lying on the tabletop, his spinal column is in the zones indicated by (13a) and (13b). Two rows of tourmaline semi-precious stones (12) are provided in these zones (13a), (13b).

This person will be in a position with his lumbar region and/or bottom in the zone indicated by the reference numeral (14). Two rows of three garnet semi-precious stones (12) are provided in that zone (14).

The person lying on the therapeutic table will be in a position with the dorsal region of the body in the zones (15a), (15b). Two rows of bloodstone semi-precious stones (12) are provided in each of these zones.

The person lying on the therapeutic table will be in a position with his shoulders, hip parts, bottom and legs in the zones indicated by the reference numerals (16a), (16b), (16c), (16d), (16e), (16f). A number of coral semi-precious stones or jaspis semi-precious stones (12) are provided in each of these zones.

The abovementioned semi-precious stones are therefore in each case provided at the level of those places of the body where their effect is greatest. The therapeutic effects which can be obtained for a person lying on the heated tabletop (1) can be read in Table 1 below.

In a particular embodiment the therapeutic table (see FIG. 1) is provided with a curved wall (5) extending upwards from the lower side of the base element (3) on one side of the table and ending with a part (6) which provides a roof over the treatment surface (2).

The part (6) of this wall (5) extending above the treatment surface (2) is covered with a mirror-like material on the underside. A number of infrared radiation elements (not illustrated in the figures), directed towards the treatment surface, are also provided on the underside.

The roof part (6) is illustrated in the use position in FIG. 1. This part (6) can be moved out of this position along a path in the shape of the arc of a circle and tilted to an ‘open position’, in which this part (6) is situated substantially alongside the treatment surface (2).

In Tables 1, 2 and 3 below you will find a number of therapeutic effects which can be obtained with the device according to this invention for various semi-precious stones (Table 1), for various precious stones (Table 2), and for gold, silver and copper (Table 3).

TABLE 1

| SEMI-PRECIOUS STONES | THERAPEUTIC EFFECT |
|---|---|
| CRYSTAL | Balances and restores the body. Removes |
| | obstructions, accumulations and blockages, so that |
| | energy can move freely. So crystal helps to combat |
| | dizziness, diarrhoea and haemorrhages. |
| MOONSTONE | It stimulates the growth process. Has a healing |
| | effect on endocrine imbalance in women. Helps to |
| | cleanse a blocked lymphatic system. |
| PEARL | The high calcium content has healing properties for |
| | anyone suffering from calcium deficiency. Great |
| | help for osteoporosis. |
| BLOODSTONE | Has a warming effect on the body. Is therapeutic in |
| | cases of anaemia, inadequate nutrition, listlessness |
| | and narcolepsy. Also good for women during |
| | menstruation. Great help in cases of iron deficiency |
| | in the blood. |
| GARNET | Good for the treatment of depression, rheumatism |
| | and arthritis. |
| RED JASPER | Provides earth energy as protection. Good for |
| | treatment of liver and stomach disorders and infections. |
| RED JASPIS (SILEX) | Stimulates blood circulation and energy flow and |
| | contains a large quantity of iron. |
| CARNELIAN | Gives settled and secure feeling. Influences and |
| | regulates digestion and assimilation. Helps with |
| | food poisoning, rheumatism and wounds. |
| FIRE OPAL | Breaks up any form of crystallization (gallstones, |
| | bladder stones and kidney stones). Aids the |
| | digestive system. Gives an energy shot where necessary. |
| YELLOW TOPAZ | Aids concentration. Strengthens the heart; brings |
| | balance to the nervous system, particularly in the |
| | stomach area (“stomach anxiety”). Strengthens the |
| | spine. Promotes mental and physical digestion. |
| | Good against the cold. Restores the sense of touch |
| | (“liver”). |
| AMBER | Cleanses the whole system. Aids the digestive |
| | system and the endocrine glands; gives warmth. In |
| | adults helps with stomach anxiety, liver complaints, |
| | asthma and infections. Assists formation of teeth in babies. |
| LEMON QUARTZ | The lighter tints have a beneficial effect on |
| | endocrine glands. Cleansing action. |
| | Darker tints have a beneficial effect on dispelling |
| | anxieties blocking the solar plexus. Helps with |
| | diabetes; clears the skin. |
| COMMON TOURMALINE | Unrivalled help with the nervous system. Retains |
| | equilibrium at all levels. |
| PINK TOURMALINE | Calms the heart. |
| TOURMALINE | Balances polarity. Harmonizes and restores the |
| | influence on the heart and nervous system. Helps in |
| | change of cell structure. Preventive in cancer cases |
| | by constantly balancing and containing metastasis |
| | and irregular cell growth. Good for treatment of exhaustion. |
| WATER MELON KUNZITE | Removes and relieves the heart of old pains. |
| RHODOCHROSITE | Integrates, brings together physical, mental and |
| | emotional. Is a good transmitter of warmth and |
| | energy. Calms and warms the heart. Good for |
| | anyone who is run down. |
| EMERALD | Helps with the development and revitalization of a |
| | beautiful physical body. Balances the healing |
| | process. Normalizes blood pressure. Good for eye infections. |
| MALACHITE | Brings the whole system into balance. Helps with |
| | pancreas and spleen functions. Good against eye |
| | infections, asthma, menstruation disorders, |
| | poisoning and rheumatism. |
| JADE | Soothing. General healing and balance-restoring |
| | properties. Good in childbirth and for influenza, |
| | neuralgia and migraine. |
| GREEN TOURMALINE | Puts the mind at rest through the nervous system. |
| | Promotes recovery and rejuvenation of the whole |
| | body. Good against infection, asthma, heart |
| | problems, influenza, cancer. Regulates the blood pressure. |
| NICKEL OXIDE GREEN | Sedative and calming effect like JADE. Brings |
| COLOURED AGATE | balance and strength of purpose where there is any |
| | form of neurotic behaviour. Good for the heart, the |
| | blood flow, haemorrhage, childbirth and glands. |
| PERIDOT | Calms, cleanses and brings balance to the physical |
| | body: a cleansing effect. Good for digestion and |
| | constipation; helps in cases of inflammation of the |
| | intestines. Dispels melancholy. |
| AQUAMARINE | Excellent disinfectant for throat infections. |
| | Stabilizes and brings the body into balance. Helps |
| | with nerve pains, gland problems, neck, jaw, throat |
| | and tooth problems. A great filter. |
| TURQUOISE | Strong healing vibrations through high copper |
| | content. Good for the heart, ribcage, neck, lungs and |
| | respiratory system, and for the eyes. |
| CHRYSOCOLLA | Brings balance and calms heart and emotions. |
| | Alleviates anxiety and brings peace to the heart. |
| | Prevents digestion problems and ulcers. |
| LAPIS LAZULI | Cures clogged throat; great help in cases of |
| | swelling, pain, inflammation and skin rashes. Good |
| | for depression and nerve pains. Helps against fever, |
| | high blood pressure and painful menstruation. |
| BLUE TOPAZ | Cooling, calming, cleansing for nerves and throat. A |
| | strong electrical and magnetic force. Good against |
| | nervous headache and throbbing headache. |
| INDIGO SAPPHIRE | Strong healing properties in the treatment of mental |
| | confusion and delirium. |
| COPPER LAZULITE | A great healing force anywhere in the body because |
| | it revitalizes damaged parts. Assists memory. |
| AMETHYST | High-density vibration good at relieving any form |
| | of pain. Dispels rage, fury, fear, anxiety. Brings |
| | comfort and relief for psychological complaints. |
| | Good for treatment of blood poisoning and sex |
| | problems. Great help for headache, migraine and |
| | insomnia. Stabilizes and brings balance in sexual |
| | problems (polarity). Good against colour blindness |
| | and alcohol problems. |
| FLUORITE | The violet FLUORITE works a little like the |
| | AMETHYST. The GREEN helps the individual in |
| | his possibilities for treating high-frequency |
| | vibrations; calms the nervous system. |

TABLE 2

| PRECIOUS STONES | THERAPEUTIC EFFECT |
|---|---|
| DIAMOND | A great help against blood poisoning and |
| | in cancer therapy. |
| RUBY | Activates and vitalizes the body by way |
| | of the bloodstream. Also used to prevent |
| | miscarriages. |
| SAPPHIRE | Particularly healing for sore throat. |
| | Cleansing action. Lowers blood pressure; |
| | relieves pain; lowers high temperature |
| | and is good for nervousness and |
| | insomnia. |

TABLE 3

| METALS | THERAPEUTIC EFFECT |
|---|---|
| GOLD | A great help against high blood pressure |
| | (blood-pressure-reducing effect), balance |
| | disorders, heart complaints, slipped disc, |
| | liver complaints, back complaints, |
| | paralysis. Has a blood-cleansing effect. |
| | Regulates the nerve conduction capacity |
| | of the nerves. |
| SILVER | Great help against epilepsy, gastritis, |
| | insomnia, diabetes. Has a blood- |
| | purifying effect. |
| COPPER | Great help for slimming, eczema, |
| | bruises, infections, wounds (healing |
| | effect). Strengthens the kidneys. Has a |
| | blood-purifying effect. Promotes the |
| | absorption of iron in the small intestine |
| | and takes care of the conversion of the |
| | stored iron into a form which can be |
| | transported by the blood. It works as a |
| | catalyst in the production of |
| | haemoglobin and the formation of |
| | enzymes which keep the blood vessels |
| | elastic. |

1. Therapeutic device, comprising a bearing element (1), one surface of which is provided as a treatment surface (2), and means (4) for heating said bearing element, characterized in that the bearing element consists substantially of a natural stone and on the treatment surface (2) is provided with a number of therapeutic units (12) which can comprise at least one product from the following group: semi-precious stone, precious stone, precious metal, copper, so that during use of the device the body of a person or animal present on the treatment surface (2) comes into direct contact with the abovementioned therapeutic units (12).

2. Therapeutic device according to claim 1, characterized in that the abovementioned heating means (4) are provided in order to bring the treatment surface (2) to a temperature lying between 40° C. and 50° C., preferably approximately 49° C. to 50° C.

3. Therapeutic device according to claim 1, characterized in that the abovementioned heating means (4) comprise a hot water circuit, which is provided in order to heat the bearing element (1).

4. Therapeutic device according to claim 1, characterized in that the bearing element (1) is composed substantially of steatite or lava rock.

5. Therapeutic device for carrying out a therapeutic treatment according to claim 1, characterized in that the therapeutic units (12) comprise one or more semi-precious stone materials from the following group: crystal, moonstone, pearl, coral, red jaspis, garnet, red jasper, bloodstone, carnelian, fire opal, yellow topaz, amber, lemon quartz, common tourmaline, pink tourmaline, tourmaline, water melon kunzite, rhodochrosite, emerald, malachite, jade, green tourmaline, nickel oxide green coloured agate, peridot, aquamarine, turquoise, chrysocolla, lapis lazuli, blue topaz, indigo sapphire, copper lazulite, amethyst and fluorite.

6. Therapeutic device according to claim 1, characterized in that the therapeutic units (12) comprise one or more precious stone materials from the diamond, ruby and sapphire group.

7. Therapeutic device according to claim 1, characterized in that a lying zone for a human or animal body is indicated on the treatment surface, and in that the therapeutic units (12) are provided within this lying zone on the treatment surface (2).

8. Therapeutic device according to claim 1, characterized in that on the treatment surface (2):
in a zone (13a), (13b) which is provided for the spinal column of a person to be treated, one or more therapeutic units (12) comprising tourmaline are provided and/or,
in a zone (14) which is provided for the lumbar region and/or the bottom of a person to be treated, one or more therapeutic units (12) comprising garnet are provided, and/or
in a zone (15a), (15b) which is provided for the dorsal part of a person to be treated, one or more therapeutic units (12) comprising bloodstone are provided, and/or
in a zone (16a), (16b), (16c), (16d), (16e), (16f) which is provided for a shoulder or a hip part or the bottom or the legs of a person to be treated, one or more therapeutic units (12) comprising coral and/or red jaspis are provided.

9. Therapeutic device according to claim 1, characterized in that said therapeutic device comprises a superstructure (6) which is provided so as to extend above the treatment surface (2) during use of the device.

10. Therapeutic device according to claim 9, characterized in that the superstructure (6) is removable or can be moved to a position in which the treatment surface (2) is largely not covered by said superstructure (6).

11. Therapeutic device according to claim 1, characterized in that a wall of the abovementioned superstructure (6) facing the treatment surface (2) has a reflective or a mirror-like surface.

12. Therapeutic device according to claim 1, characterized in that said device comprises means for generating infrared radiation.
